(19) United States
(12) Patent Application Publication
(10) Pub. No.: US 2011/0059216 A1
(43) Pub. Date: Mar. 10, 2011

(54) Accessory straws

(76) Inventor: Maluki C. Takumah, Atlanta, GA (US)

(21) Appl. No.: 12/927,140

(22) Filed: Nov. 8, 2010

Related U.S. Application Data
(63) Continuation-in-part of application No. 11/827,281, filed on Jul. 11, 2007.
(60) Provisional application No. 60/830,920, filed on Jul. 14, 2006.

(51) Int. Cl. A47G 21/18; A23P 1/00; A23L 2/00

(52) U.S. Cl. 426/519; 366/129

(57) ABSTRACT

An accessory straw is provided for use with containers for consumable beverages, in which the accessory straw can be used to mix and/or consume the beverage and to prevent or at least minimize separation of the beverage into component phases or layers.

This application is a continuation-in-part of U.S. patent application Ser. No. 11/827,281, filed Jul. 11, 2007, which claims the benefit of U.S. Provisional Patent Application Ser. No. 60/830,920, filed Jul. 14, 2006.

### TECHNICAL FIELD

The present invention relates to accessory straws. In a more specific aspect, this invention relates to accessory straws for use with containers of consumable beverages.

In this application, the following terms will be understood to have the indicated definitions:
mixing—refers to the mixing (i.e., stirring) and pre-mixing of a consumable beverage.
beverage—refers to any liquid intended for consumption by a person, such as alcoholic beverages, mixed drinks, soft drinks, powdered soft drinks, etc.
consumable—refers to a beverage which is primarily intended for consumption by a person.
accessory straw—a straw which provides or adds convenience or effectiveness to the enjoyment and consumption of a beverage.

### BACKGROUND OF THE INVENTION

In today's society, beverages of many types are consumed by persons at an increasing rate. Alcoholic and non-alcoholic beverages are consumed at breakfast, lunch, dinner and at various times throughout the day. Beverages are consumed for many reasons, such as nourishment, thirst, societal, replacement of minerals and/or vitamins, etc.

Many beverages primarily consist of a single liquid phase, such as wine, beer, milk, etc. However, other beverages may contain more than one liquid phase, such as mixed drinks, coffee with cream and sugar, etc. In either case, the beverage should be mixed (i.e., stirred) at least occasionally for purposes of taste and enjoyment. This objective to mix is most evident after a multi-phase beverage is placed or poured into a container, such as a glass or cup, to prevent or at least minimize the separation of the beverage into component phases (or layers).

Additionally, many current beverage containers are one-piece, which means that the entire container may have to be destroyed if a crack develops in the container or if the container is broken. This, of course, leads to a certain amount of unrecoverable waste.

While accessories for beverage containers are currently available, such as straws, stirrers and swizzle sticks, the beverage-consuming public continues to look for new accessories which will enhance their enjoyment and consumption of beverages, especially multi-phase beverages.

Therefore, there is a need for new and effective accessory straws.

### SUMMARY OF THE INVENTION

Briefly described, the present invention provides an accessory straw for use with containers of consumable beverages, in which the accessory straw provides or adds to the enjoyment of the beverage.

Accordingly, an object of this invention is to provide a much needed accessory straw for use with containers of consumable beverages.

Another object of this invention is to provide an accessory straw for use with containers of consumable beverages, wherein a beverage can be consumed through the accessory straw.

Another object of this invention is to provide an accessory straw for use with containers of consumable beverages, wherein the accessory straw can be used to stir or mix the beverage.

Another object of this invention is to provide an accessory straw for use with containers of consumable beverages, wherein the straw can be used to prevent or at least minimize separation of the beverage into component phases or layers.

Another object of this invention is to provide a process for stirring (i.e., mixing) of consumable beverages.

Another object of this invention is to provide a process for stirring or mixing a consumable beverage wherein separation of the beverage into component phases or layers is prevented or at least minimized.

These and other objects, features and advantages of this invention will become apparent from the following detailed description.

### BRIEF DESCRIPTION OF THE DRAWINGS

FIG. 1 is a view of an accessory straw according to this invention, shown in a closed or “before” position.

FIG. 2 is a view of an accessory straw according to this invention, shown in an open or “after” position, with an enlargement of a cutaway view of a base portion of the accessory straw.

FIG. 3 is an enlarged view of the accessory straw shown in FIG. 2, shown in an open or “after” position.

FIG. 4 is a view of an accessory straw according to this invention, with a design on the straw portion, shown in an open or “after” position.

FIG. 5 is a view of an accessory straw according to this invention, shown in the partially open, closed and open positions, with an enlargement of a cutaway view of a portion of the accessory straw.

FIG. 6 is a view of an accessory straw according to this invention, shown in the closed, partially open, and open positions, with an enlargement of a cutaway view of the accessory straw.

FIG. 7 is a view of an accessory straw according to this invention, shown in the closed and open positions, and shown with notches as stops.

FIG. 8 is a view of an accessory straw according to this invention, shown in the closed and open positions, and shown with an alternative configuration of the stops.

FIG. 9 is a view of the accessory straw shown in FIG. 7 after insertion into a beverage container.

FIG. 10 shows in 4 steps how the accessory straw of this invention can be used to stir and/or consume a beverage.

### DETAILED DESCRIPTION OF THE INVENTION

The present invention relates to an accessory straw for use with various types of containers of consumable beverages.

Preferred configurations of an accessory straw according to this invention are shown in the drawings of this application.

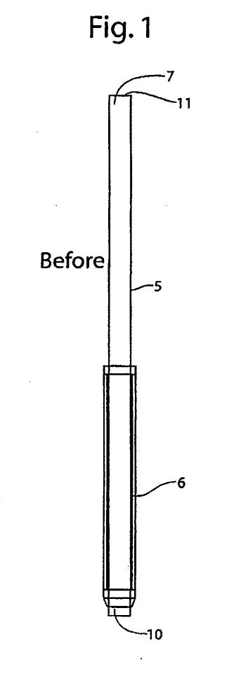

Referring now to the drawings, in which like numbers represent like elements, FIG. 1 shows an accessory straw 5 having a mixing means 6 shown in a closed position. In FIG. 1, straw 5 is an elongated tubular device having a hollow interior 7, an exposed top end 11 and an exposed bottom end 10.

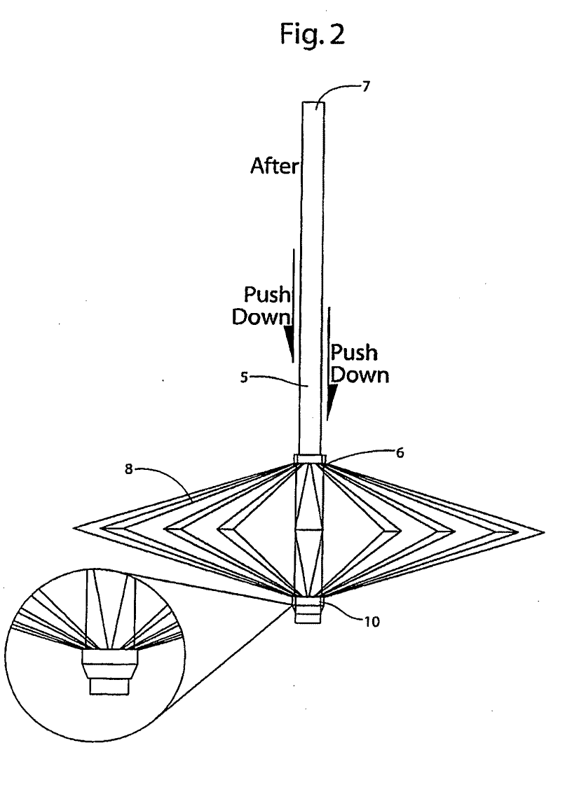

FIG. 2 shows an accessory straw 5 in which the mixing means 6 is in an open or fluted position 8. FIG. 2 also shows an enlarged view of the exposed bottom end 10 of straw 5.

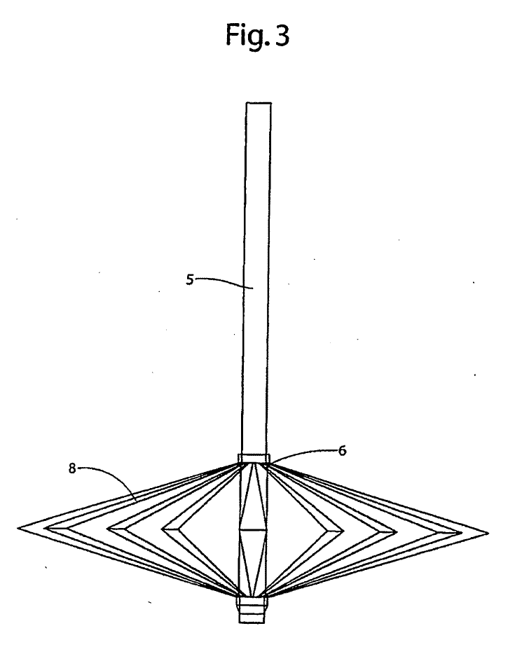

FIG. 3 shows an enlarged view of the embodiment shown in FIG. 2, with straw 5 and mixing means 6 in an open or fluted position 8.

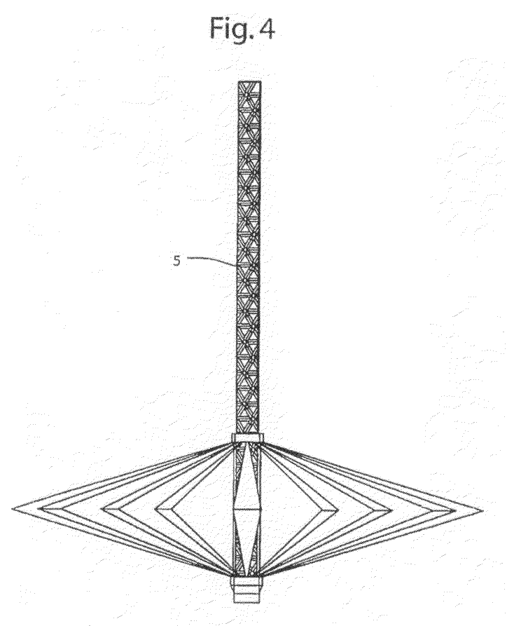

FIG. 4 shows an enlarged view of the embodiment shown in FIG. 3, but with a design on an outside portion of straw 5.

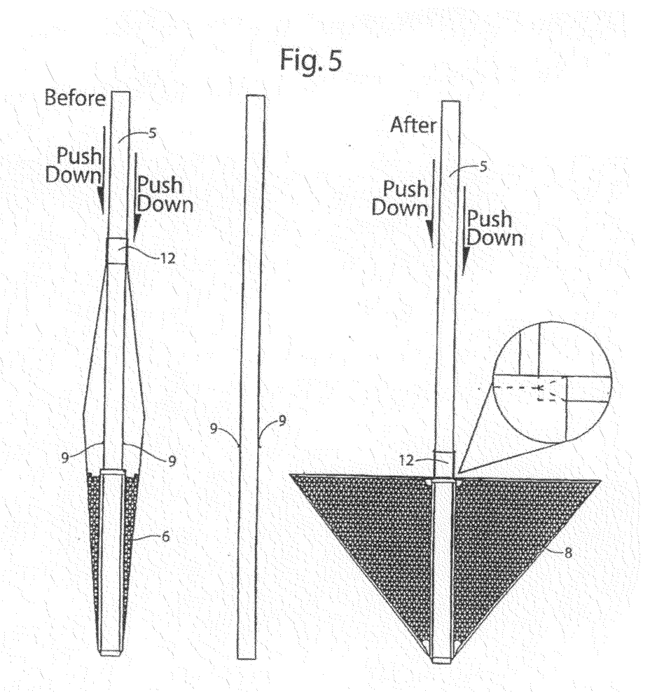

FIG. 5 shows another embodiment of an accessory straw according to this invention. The middle drawing of FIG. 5 shows a cross-sectional view of straw 5 in a closed position with stops 9. The left drawing of FIG. 5 shows straw 5 with mixing means 6 in a partially closed position with stops 9 and gripping means 12. The right drawing of FIG. 5 shows straw 5 with mixing means 6 in the open or fluted position 8. By using gripping means 12 and moving mixing means 6 in the direction shown by the arrows, mixing means 6 is moved until stops 9 prevent further movement, and mixing means 6 is then in an open or fluted position.

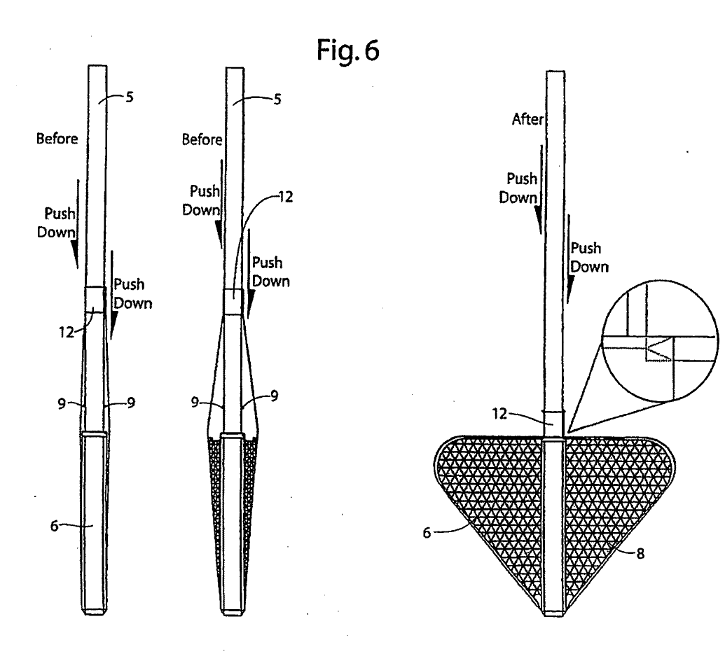

FIG. 6 shows another embodiment of an accessory straw according to this invention. The middle drawing of FIG. 6 shows a cross-sectional view of straw 5 in a partially open position with stops 9 and gripping means 12. The left drawing of FIG. 6 shows straw 5 with mixing means 6 in a closed position with stops 9 and gripping means 12. The right drawing of FIG. 6 shows straw 5 with mixing means 6 in the open or fluted position 8. By using gripping means 12 and moving mixing means 6 in the direction shown by the arrows, mixing means 6 is moved until stops 9 (not shown) prevent further movement, and mixing means 6 is then in an open or fluted position.

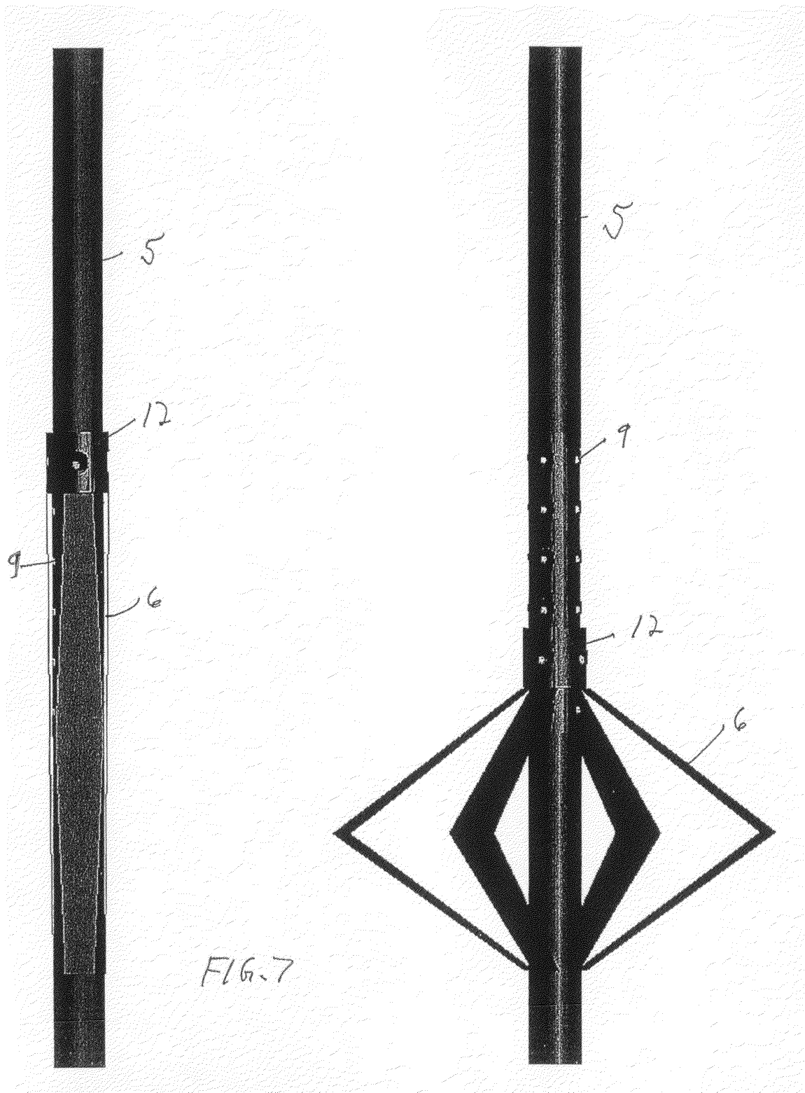

FIG. 7 shows an embodiment of this invention with straw 5, mixing means 6 and gripping means 12. In FIG. 7, stops 9 are shown as notches. The left drawing of FIG. 7 shows straw 5 with mixing means 6 in the closed position. The right drawing of FIG. 7 shows straw 5 with mixing means 6 in the open or fluted position.

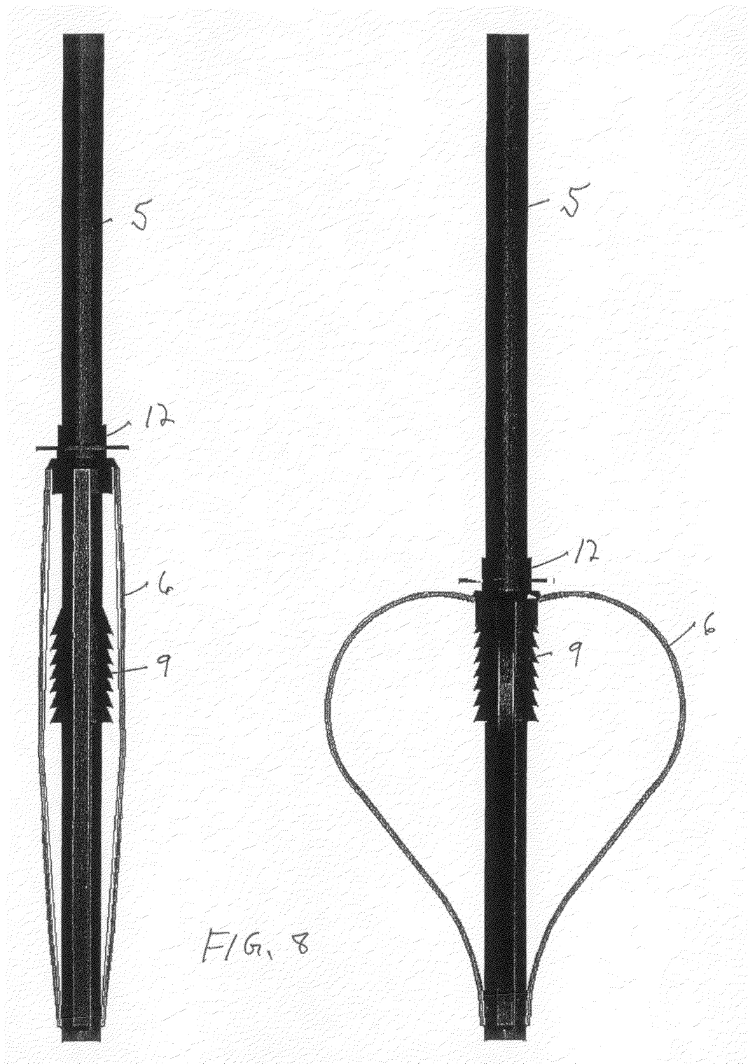

FIG. 8 shows an embodiment of this invention with straw 5, mixing means 6 and gripping means 12. In FIG. 8, stops 9 are shown with an alternative configuration. In FIG. 8, the left and right drawings show straw 5 with mixing means 6 in the closed and open positions, respectively.

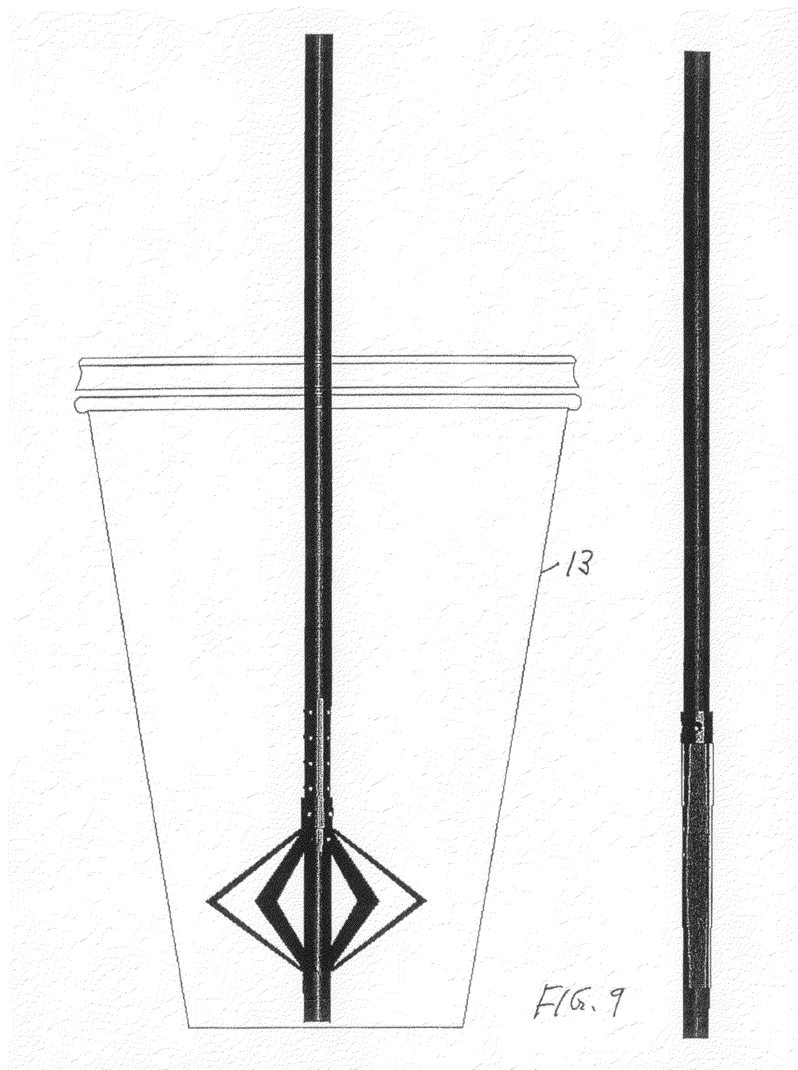

FIG. 9 shows the accessory straw shown in FIG. 7 in the open or fluted position and after insertion into a beverage container 13.

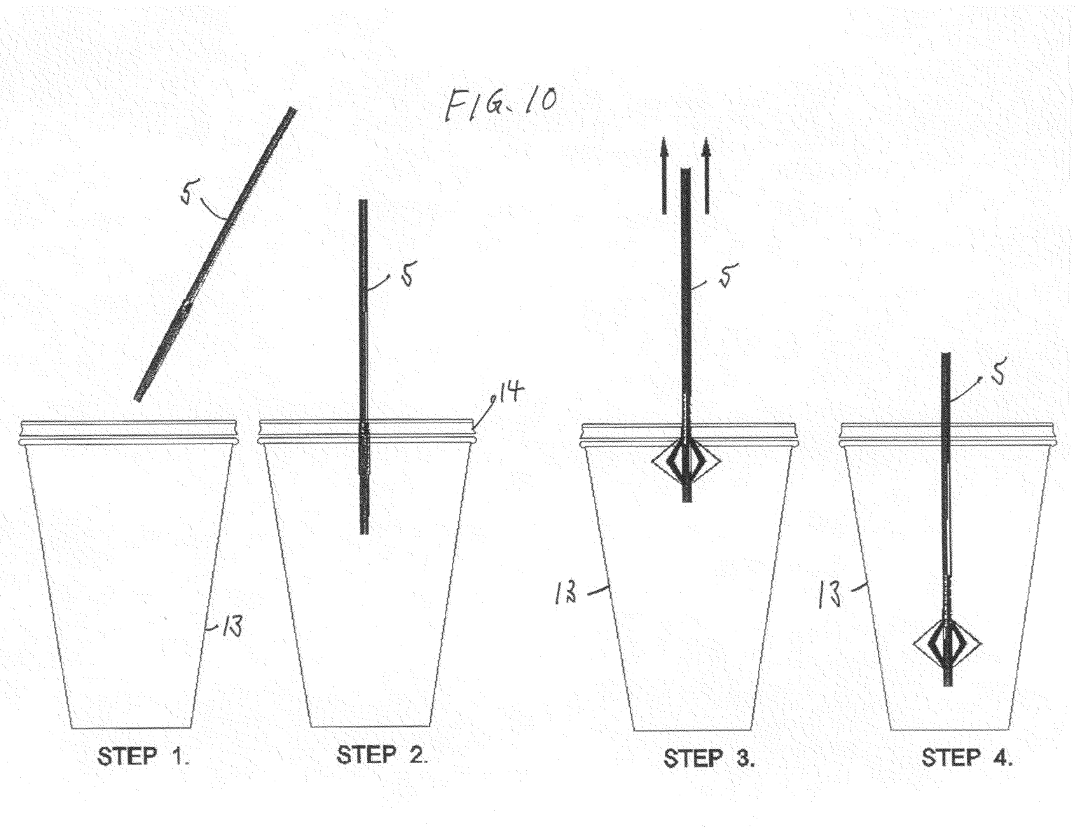

FIG. 10 shows in 4 steps how the accessory straw of this invention can be used to stir and/or consume a beverage. In Step 1, the beverage container 13 with a consumable beverage (not shown) is shown with the straw 5 in a closed position above the beverage container. In Step 2, straw 5 has been inserted through an opening (not shown) in lid 14 for beverage container 13, with straw 5 still in a closed position. In step 3, straw 5 is positioned in beverage container 13 in the open or fluted position through use of gripping means 12 and stops 9. In Step 4, straw 5 in the open or fluted position is shown after being further moved downwardly in beverage container 13. In Steps 2, 3 and 4, straw 5 can be used to consume the beverage. In Steps 3 and 4, straw 5 can also be used to stir or mix the beverage.

In this invention, the accessory straw can have a hollow or at least partially hollow interior and can be made of various materials, such as stainless steel, polymeric materials such as polycarbonate, plastic materials, glass, etc., and can be of various lengths and widths. If the interior is hollow or at least partially hollow, the accessory straw can be used to stir, mix and consume a beverage.

The mixing means can be of any shape, such as blades and strips, and also can be of different sizes and numbers. To effectively function as part of the accessory straw, there must be a plurality (i.e., at least 2) of the mixing means.

The stops 9 can be of any configuration, such as the notches as shown in FIG. 7 or the inverted configuration as shown in FIG. 8. The stops 9 must mate or engage with an opposing feature of the gripping means 12 so that the mixing means 6 can be in the preferred position (i.e. open or partially open) for the desired use.

In practice, the accessory straw of this invention is used to mix and/or consume a beverage. The accessory straw of this invention is equipped with a mechanism (i.e., mixing means 6) which can be opened by the user either with a downward or pushing motion or with an upward or pulling motion to form an open or fluted position. Once opened, the straw 5 can then be used to mix or stir the beverage and to prevent or at least minimize separation of the beverage into component phases or layers. The straw can also be used to consume the beverage if the interior of the straw is hollow or at least partially hollow.

This invention has been described with particular reference to certain embodiments, but variations and modifications can be made without departing from the spirit and scope of the invention.

1. An elongated tubular device comprising:
A. an exposed top end and an exposed bottom end;
B. mixing means located on an outside portion of the tubular device and which is movable between a closed position and an open fluted position;
C. gripping means located on the mixing means to enable a user to move the mixing means between a closed position and an open fluted position; and
D. stop means located on an outside portion of the device to prevent movement of the mixing means beyond a pre-determined point.

2. An elongated tubular device as defined by claim 1 wherein the polymeric material is a polycarbonate.

3. An elongated tubular device as defined by claim 1 wherein the device has a hollow interior.

4. An elongated tubular device as defined by claim 1 wherein the device has an at least partially hollow interior.

5. A process for stirring and consuming a consumable beverage, wherein the consumable beverage is stirred with an elongated tubular device comprising:
A. an exposed top end and an exposed bottom end;
B. mixing means located on an outside portion of the tubular device and which is movable between a closed position and an open fluted position;
C. gripping means located on the mixing means to enable a user to move the mixing means between a closed position and an open fluted position; and
D. stop means located on an outside portion of the device to prevent movement of the mixing means beyond a pre-determined point; and
E. consuming the beverage through the elongated tubular device;
wherein the elongated tubular device has an at least partially hollow interior and is made of a polycarbonate.

6. A process as defined by claim 5 wherein the elongated tubular device is made of a polycarbonate.

7. A process as defined by claim 5 wherein the elongated tubular device has a hollow interior.

8. A process as defined by claim 5 wherein the elongated tubular device has an at least partially hollow interior.
